(19) United States
(12) Patent Application Publication
(10) Pub. No.: US 2024/0093401 A1
(43) Pub. Date: Mar. 21, 2024

(54) METHOD OF MANUFACTURING MULTILAYER METAL PLATE BY ELECTROPLATING AND MULTILAYER METAL PLATE MANUFACTURED THEREBY

(71) Applicant: DONG-A UNIVERSITY RESEARCH FOUNDATION FOR INDUSTRY-ACADEMY COOPERATION, Busan (KR)

(72) Inventors: Hyun PARK, Suwon-si (KR); Sung Jin KIM, Busan (KR); Han Kyun SHIN, Busan (KR); Hyo Jong LEE, Busan (KR); Jong Bae JEON, Busan (KR); Jung Han KIM, Changwon-si (KR); An Na LEE, Seoul (KR); Tae Hyun KIM, Anyang-si (KR); Hyung Won CHO, Seongnam-si (KR)

(73) Assignee: DONG-A UNIVERSITY RESEARCH FOUNDATION FOR INDUSTRY-ACADEMY COOPERATION, Busan (KR)

(21) Appl. No.: 18/469,034

(22) Filed: Sep. 18, 2023

(30) Foreign Application Priority Data
Sep. 19, 2022 (KR) 10-2022-0118092

(51) Int. Cl. C25D 5/12; C25D 3/12; C25D 3/38; C25D 5/00; C25D 21/12; H01M 4/66

(52) U.S. Cl. CPC C25D 5/12; C25D 3/12; C25D 3/38; C25D 5/617; C25D 21/12; H01M 4/661; H01M 4/667

(57) ABSTRACT

A method of manufacturing a multilayer metal plate by electroplating includes a first forming operation of forming one of a first metal layer and a second metal layer on a substrate by electroplating, wherein the second metal layer is less recrystallized than the first metal layer, the second metal layer is comprised of nanometer-size grains, and the second metal layer has a higher level of tensile strength than the first metal layer; and a second forming operation of forming, by electroplating, a third metal layer not formed in the first forming operation on a surface of one of the first metal layer and the second metal layer formed in the first forming operation.

### CROSS-REFERENCE TO RELATED APPLICATION

This application claims the benefit under 35 USC § 119(a) of Korean Patent Application No. 10-2022-0118092 filed on Sep. 19, 2022, the entire contents of which is incorporated herein by reference for all purposes.

### BACKGROUND

### 1. Field

The following disclosure relates to a method of manufacturing a multilayer metal thin plate by electroplating and a multilayer metal thin plate manufactured thereby.

### 2. Description of Related Art

It is generally known that a rechargeable battery or a fuel cell has a structure including a negative electrode current collector and a positive electrode current collector, with an electrolyte or an active material being provided between the negative electrode current collector and the positive electrode current collector. The negative electrode current collector of the rechargeable battery or the fuel cell is generally implemented as a metal thin plate made of a metal such as nickel (Ni) or copper (Cu).

In addition, the use of secondary batteries and fuel cells as clean energy is continuously increasing in all industries such as automobiles and energy. As the use of secondary batteries and fuel cells continuously increases, demand for secondary batteries and fuel cells having high energy density and high efficiency is also increasing.

As one of methods for obtaining high energy density and high efficiency of secondary batteries and fuel cells, a technology for reducing the thickness of a metal thin plate used in the above-described negative electrode current collector to the level of several to tens of micrometers and thus reducing the thickness of the negative electrode current collector so as to increase the capacity of a secondary battery was developed.

However, when the thickness of the metal thin plate is reduced, mechanical properties of the metal thin plate such as tensile strength and elongation may be degraded. The metal thin plate may be easily cracked due to thermal/mechanical impacts applied during fabrication of the secondary battery, deformations in the current collector caused by a charging/discharging cycle in charging/discharging of the secondary battery, or the like. As a result, the durability of the secondary battery and the fuel cell may disadvantageously degrade.

The foregoing is intended merely to aid in the understanding of the background of the present disclosure, and is not intended to mean that the present disclosure falls within the purview of the related art that is already known to those skilled in the art.

Related Art includes Korean Patent Application Publication No. 10-2018-0090532 and Korean Patent Application Publication No. 10-2021-0062369.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of manufacturing a multilayer metal plate by electroplating, includes: a first forming operation of forming one of a first metal layer and a second metal layer on a substrate by electroplating, wherein the second metal layer is less recrystallized than the first metal layer, the second metal layer is comprised of nanometer-size grains, and the second metal layer has a higher level of tensile strength than the first metal layer; and a second forming operation of forming, by electroplating, a third metal layer not formed in the first forming operation on a surface of one of the first metal layer and the second metal layer formed in the first forming operation.

The multilayer metal plate may be manufactured having a thickness higher than 0 μm and being equal to or lower than 10 μm, and having a tensile strength of 74.3 to 111.4 kgf/mm2.

In the first forming operation, the first metal layer comprising a metal including at least one selected from among Cu, Ag, and Au may be formed, and in the second forming operation, the second metal layer comprising a metal including at least one selected from among Ni, Pt, Ru, and Rh may be formed.

The multilayer metal plate in which a ratio of the thickness of the second metal layer with respect to the first metal layer is 1 to 9 may be manufactured.

The first forming operation may include: manufacturing a first plating solution comprising Cu ions, sulfuric acid, Cl ions, a plating suppressor, and a plating accelerator; and immersing the substrate into the first plating solution and electroplating the substrate with the first metal layer, wherein the second forming operation may include: manufacturing a second plating solution comprising Ni ions, Cl ions, boric acid ions, sodium dodecyl sulfate, and saccharin; and immersing the substrate having the first metal layer thereon into the second plating solution and forming the second metal layer by electroplating.

The manufacturing of the first plating solution may manufacture the first plating solution comprising 0.3 to 1 M of the Cu ions, 0.1 to 2 M of the sulfuric acid, 0.5 to 1 mM of the Cl ions, 0.06 to 0.1 μM of polyethylene glycol as the plating suppressor, and 15 to 100 μM of sodium dodecyl sulfate as the plating accelerator, and the electroplating of the first metal layer may electroplate the first metal layer by applying current to the first plating solution so that a countable current density value according to a reaction area between the substrate and the first plating solution is 50 to 300 mA/cm2.

The manufacturing of the second plating solution may manufacture the second plating solution comprising 0.3 to 3 M of the Ni ions, 0.1 to 1 M of the Cl ions, 0.3 to 1 M of the boric acid ions, 0.002 to 0.007 M of the sodium dodecyl sulfate, and 0.003 to 0.011 M of the saccharin, and the electroplating of the second metal layer may electroplate the second metal layer by applying current to the second plating solution so that a countable current density value according to a reaction area between the substrate and the second plating solution is 50 to 500 mA/cm2.

In another general aspect, a multilayer metal plate may include: a first metal layer; and a second metal layer formed on the first metal layer, wherein the second metal layer may be less recrystallized than the first metal layer, wherein the second metal layer may be comprised of nanometer-size grains, and wherein the second metal layer may include a higher level of tensile strength than the first metal layer.

The multilayer metal plate may have a thickness of higher than 0 μm and equal to or lower than 10 μm, and a tensile strength of 74.3 to 111.4 kgf/mm2.

The first metal layer may comprise a metal including at least one selected from among Cu, Ag, and Au, and the second metal layer may comprise a metal including at least one selected from among Ni, Pt, Ru.

In case the multilayer metal plate is used as a negative electrode current collector in a rechargeable battery or a fuel cell, the different sizes of grains in the first metal layer, the second metal layer, and the third metal layer may improve tensile strength and increase durability of the multilayer metal plate in comparison to a multilayer metal plate comprising one or two metal layers.

Effects obtainable from the present disclosure are not limited to the aforementioned effects, and other effects not explicitly disclosed herein will be clearly understood by those skilled in in the art from the description provided hereinafter.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a flowchart illustrating an example of the sequence of a method of manufacturing a multilayer metal thin plate by electroplating according to an embodiment of the present disclosure;

FIG. 2 is a cross-sectional view illustrating a multilayer metal thin plate according to an embodiment of the present disclosure;

FIG. 3 is a diagram illustrating an electron backscatter diffraction (EBSD) analysis result of Test Example 2 performed on a multilayer metal thin plate manufactured according to Example 1;

FIG. 4 is a diagram illustrating an EBSD analysis result of Test Example 2 performed on a multilayer metal thin plate manufactured according to Example 2;

FIG. 5 is a diagram illustrating an EBSD analysis result of Test Example 2 performed on a multilayer metal thin plate manufactured according to Example 3;

FIG. 6 is a diagram illustrating an EBSD analysis result of Test Example 2 performed on a multilayer metal thin plate manufactured according to Example 4;

FIG. 7 is a diagram illustrating an EBSD analysis result of Test Example 2 performed on a multilayer metal thin plate manufactured according to Comparative Example 1;

FIG. 8 is a diagram illustrating an EBSD analysis result of Test Example 2 performed on a multilayer metal thin plate manufactured according to Comparative Example 2;

FIG. 9 is a diagram illustrating an EBSD analysis result of Test Example 2 performed on a multilayer metal thin plate manufactured according to Comparative Example 3;

FIG. 10 is a diagram illustrating an EBSD analysis result of Test Example 2 performed on a multilayer metal thin plate manufactured according to Comparative Example 4;

FIG. 11 is a diagram illustrating an EBSD analysis result of Test Example 2 performed on a first metal layer manufactured according to Comparative Example 5;

FIG. 12 is a diagram illustrating an EBSD analysis result of Test Example 2 performed on a first metal layer manufactured according to Comparative Example 6; and

FIG. 13 is a diagram illustrating an EBSD analysis result of Test Example 2 performed on a first metal layer manufactured according to Comparative Example 7.

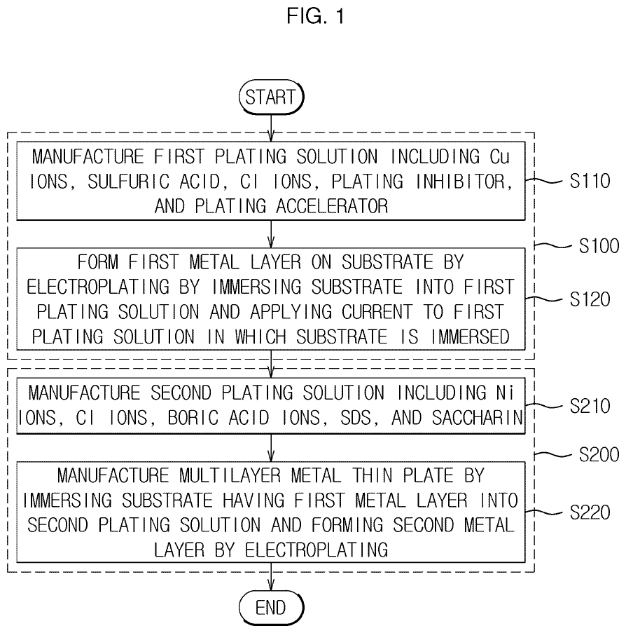

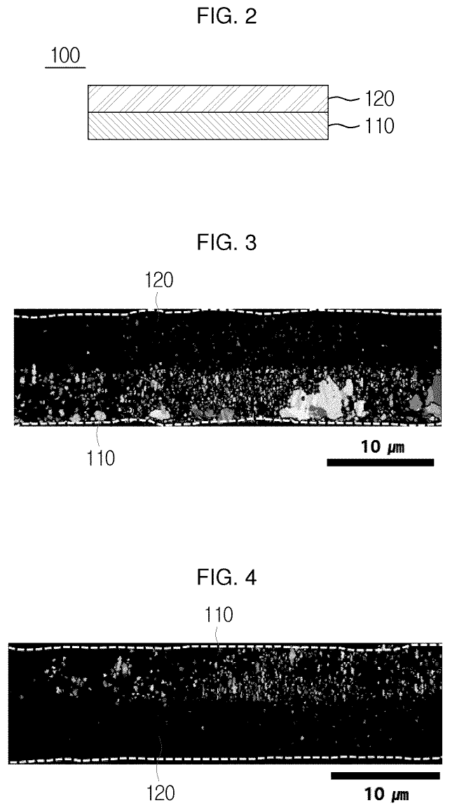

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

As used herein, the singular forms are intended to include the plural forms as well, unless the context clearly indicates otherwise. The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein. The use of the term “may” herein with respect to an example or embodiment (e.g., as to what an example or embodiment may include or implement) means that at least one example or embodiment exists where such a feature is included or implemented, while all examples are not limited thereto.

Also, in the description of example embodiments, detailed description of structures or functions that are thereby known after an understanding of the disclosure of the present application will be omitted when it is deemed that such description will cause ambiguous interpretation of the example embodiments.

Hereinafter, examples will be described in detail with reference to the accompanying drawings, and like reference numerals in the drawings refer to like elements throughout.

A method of manufacturing a multilayer metal thin plate by electroplating according to an embodiment of the present disclosure is a method of manufacturing a multilayer metal thin plate according to another embodiment of the present disclosure. In description of a multilayer metal thin plate by electroplating and a multilayer metal thin plate manufactured thereby according to embodiments of the present disclosure, the same reference numerals will be used to designate the same components, and repeated descriptions thereof will be omitted.

Hereinafter, a method of manufacturing a multilayer metal thin plate by electroplating and a multilayer metal thin plate manufactured thereby according to embodiments of the present disclosure will be described with reference to the accompanying drawings.

The method of manufacturing a multilayer metal thin plate by electroplating according to an embodiment of the present disclosure may include a first forming step S100 and a second forming step S200. A multilayer metal thin plate 100 according to another embodiment of the present disclosure may include a first metal layer 110 and a second metal layer 120.

First, one of the first metal layer 110 and the second metal layer 120 having a smaller grain size than the first metal layer 110 is formed on a substrate by electroplating in S100.

The metal layer formed on the substrate in the first forming step S100 may be any one of the first metal layer 110 and the second metal layer 120. Particularly, the metal layer may be the first metal layer 110.

The first metal layer 110 formed in the first forming step S100 may be made of a metal including at least one selected from among copper (Cu), silver (Ag), and gold (Ag). Particularly, the first metal layer 110 may be made of Cu.

When the first metal layer 110 formed in the first forming step S100 is made of a metal including at least one selected from among Cu, Ag, and Au, the growth of grains in the first metal layer 110 may be more facilitated than in the second metal layer 120. The size of the grains of the first metal layer 110 may be relatively greater. Thus, the specific resistance of the first metal layer 110 may be lower than that of the second metal layer 120.

The first forming step S100 may include a first plating solution manufacturing step S110 and a first plating step S120.

The first plating solution manufacturing step S110 may be a step of manufacturing a first plating solution including Cu ions, sulfuric acid, chlorine (CI) ions, a plating inhibitor, and a plating accelerator.

In the first plating solution manufacturing step S110, the first plating solution including Cu ions, sulfuric acid, Cl ions, a plating inhibitor, and a plating accelerator may be manufactured by mixing copper sulfate, sulfuric acid, chlorine ions, a CI ion precursor, and a plating accelerator.

Cu ions contained in the first plating solution manufactured in the first plating solution manufacturing step S110 are reduced in the first plating step S120 to manufacture the first metal layer 110. The first plating solution manufacturing step S110 may be a step of manufacturing the first plating solution in which the concentration of Cu ions ranges from 0.3 to 1M by mixing 0.3 to 1M of copper sulfate in the manufacturing of the first plating solution.

The sulfuric acid mixed in the manufacturing of the first plating solution in the first plating solution manufacturing step S110 is intended to increase the conductivity of the first plating solution to be manufactured. The sulfuric acid may be mixed so that the concentration of the sulfuric acid contained in the first plating solution is in the range of 0.1 to 2 M. Thus, the concentration of the sulfuric acid contained in the first plating solution manufactured in the first plating solution manufacturing step S110 may range from 0.1 to 2 M.

When the concentration of the sulfuric acid contained in the first plating solution in the first plating solution manufacturing step S110 is lower than 0.1 M, the plating may not be properly performed in the first plating step S120 due to low electrical conductivity of the first plating solution. When the concentration of the sulfuric acid is higher than 2M, a polarization phenomenon or the passivation of an oxidation electrode (or anode) may be caused.

Cl ions contained in the first plating solution manufactured in the first plating solution manufacturing step S110 are intended to assist in the formation of the first metal layer 110 in the first plating step S120 in which the first metal layer is formed. Cl ions may be contained in the first plating solution due to a CI ion precursor mixed in the manufacturing of the first plating solution.

The CI ion precursor mixed in the manufacturing of the first plating solution in the first plating solution manufacturing step S110 may include at least one of sodium chloride (NaCl) and hydrochloric acid, and may be mixed in a concentration of 0.5 to 1 mM. Thus, the first plating solution manufactured in the first plating solution manufacturing step S110 may include 0.5 to 1 mM of Cl ions.

The plating inhibitor and the plating accelerator contained in the first plating solution manufactured in the first plating solution manufacturing step S110 may interact with each other to prevent voids inside the first metal layer 110 formed in the first plating step S120 so that the first metal layer 110 is formed densely.

The first plating solution manufacturing step S110 may mix 0.06 to 0.1 μM of the plating inhibitor in the manufacturing of the first plating solution. Thus, the first plating solution manufactured in the first plating solution manufacturing step S110 may include 0.06 to 0.1 μM of the plating inhibitor.

When the concentration of the plating inhibitor mixed in the manufacturing of the plating solution in the first plating solution manufacturing step S110 is lower than 0.06 μM, a plating suppression effect due to the mixing of the plating inhibitor may not be sufficient.

The plating suppressor contained in the first plating solution manufactured in the first plating solution manufacturing step S110 may be used without limitations as long as the plating suppressor is used in the field of electroplating technology. For example, the plating suppressor may include at least one of a polyol-based polymer compound and an organic matter having a functional group containing a nitrogen atom.

Particularly, the plating suppressor contained in the first plating solution manufactured in the first plating solution manufacturing step S110 may be polyethylene glycol having a molecular weight of 2000 to 50000 g/mol.

The plating accelerator contained in the first plating solution manufactured in the first plating solution manufacturing step S110 may be an organic matter including at least one of a disulfide bond and a mercapto group in a molecular structure generally used in the field of electroplating technology. For example, the plating accelerator may include at least one among 3-(benzothiazolyl-2-mercapto)-propyl-sulfonic acid, sodium salt (ZPS), N,N-dimethyl-dithiocarbamic acid-3-(sulfopropyl ester) sodium salt (DPS), 3-mercaptopropyl sulfonic acid (MPSA), and 3,3′-dithiobis(1-propanesulfonic acid) disodium salt (SPS).

The first plating solution manufacturing step S110 may mix 15 to 100 μM of the plating accelerator in the manufacturing of the first plating solution. Thus, the first plating solution manufactured in the first plating solution manufacturing step S110 may include 15 to 100 μM of the plating accelerator.

When 0.06 to 0.1 μM of the plating suppressor and 15 to 100 μM of the plating accelerator are contained in the first plating solution manufactured in the first plating solution manufacturing step S110, the plating suppressor and the plating accelerator interact with each other in the formation of the first metal layer 110 in the first plating step S120, so that the first metal layer 110 may have a structure in which at least three grains are formed in the thickness direction.

When the first metal layer 110 formed in the first plating step S120 has the structure in which at least three grains are formed in the thickness direction, plastic anisotropy of the first metal layer 110 may be reduced to increase the elongation thereof. More specifically, the first metal layer 110 formed in the first plating step S120 may have 3 to 8 grains in the thickness direction.

When the concentration of the plating accelerator contained in the first plating solution manufactured in the first plating solution manufacturing step S110 is lower than 15 μM, the plating suppressor and the plating accelerator may not interact with each other in the formation of the first metal layer 110 in the first plating step S120 due to the insufficient amount of the plating accelerator.

When the concentrations of the plating suppressor and the plating accelerator contained in the first plating solution manufactured in the first plating solution manufacturing step S110 are higher than 0.1 μM and 100 μM, respectively, the interaction between the plating suppressor and the plating accelerator may occur excessively or may not occur in the formation of the first metal layer 110. Thus, the first metal layer 110 may not have the structure in which at least three grains are formed in the thickness direction, and the elongation of the first metal layer 110 may be reduced.

In S120, the first metal layer 110 is formed on the substrate by immersing the substrate into the first plating solution manufactured in the first plating solution manufacturing step S110 and then performing electroplating by applying current to the first plating solution in which the substrate is immersed.

The first plating step S120 may be a step of immersing the substrate into the first plating solution manufactured in the first plating solution manufacturing step S110, immersing an oxidation electrode and a reduction electrode (or cathode) into the first plating solution in which the substrate is immersed, and then electroplating the first metal layer 110 by applying current to the first plating solution.

The first plating step S120 may be a step of electroplating the substrate with the first metal layer 110 by applying current to the first plating solution so that a calculatable current density value according to the reaction area between the substrate and the first plating solution is 50 to 300 mA/cm2.

During the formation of the first metal layer 110 in the first plating step S120, when the calculatable current density value according to the reaction area between the substrate and the first plating solution is smaller than 50 to 300 mA/cm2, grains in the first metal layer 110 formed may irregularly grow. When the calculatable current density value is greater than 300 mA/cm2, a side reaction may occur in the formation of the first metal layer 110, thereby lowering the physical properties of the first metal layer 110.

In the formation of the first metal layer 110 in the first plating step S120, the temperature of the first plating solution may be maintained in the range of 20 to 40° C. so that the first metal layer 110 may be properly formed, and the first metal layer 110 may be formed while stirring the first plating solution.

Here, the method of stirring the first plating solution may not be limited as long as the formation of the first metal layer 110 on the substrate is not interrupted. For example, the method may use at least one among stirring using a magnetic bar, stirring using a paddle, stirring using flow of the plating solution and nozzle spraying, stirring using the movement of an object to be plated, and air stirring.

In S200, the other of the first metal layer 110 and the second metal layer 120, not formed in the first forming step S100, is formed on the surface of one of the first metal layer 110 and the second metal layer 120 formed in the first forming step S100.

The second forming step S200 may be a step of forming the second metal layer 120 on the first metal layer 110 by electroplating when the first metal layer 110 is formed in the first forming step S100 or a step of forming the first metal layer 110 on the first metal layer 110 by electroplating when the second metal layer 120 is formed in the first forming step S100.

When the second metal layer 120 is formed in the first forming step S100, the second metal layer 120 may be formed by a second plating solution manufacturing step S210 and a second plating step S220 described below. In this case, the second plating step S220 may form the second metal layer 120 on the substrate instead of on the first metal layer 110.

In addition, when the second metal layer 120 is formed in the first forming step S100 and the first metal layer 110 is formed in the second forming step S200, the first metal layer 110 may be formed using the first plating solution manufacturing step S110 and the first plating step S120. In this case, the first metal layer 110 may be formed on the second metal layer 120 instead of on the first metal layer 110.

Here, particularly, the first metal layer 110 may be formed in the first forming step S100. Thus, the second forming step S200 may be a step of forming the second metal layer 120 on the first metal layer 110 formed in the first forming step S100.

The second forming step S200 may be a step of forming the second metal layer 120 made of a metal including at least one selected from among nickel (Ni), platinum (Pt), ruthenium (Ru), and rhodium (Rh), more particularly, Ni, on the first metal layer 110.

The second forming step S200 may be a step of forming the second metal layer 120 on the surface of the first metal layer 110, more particularly, forming the second metal layer 120 on the top surface of the first metal layer 110.

When the second metal layer 120 formed in the second forming step S200 is made of a metal including at least one selected from among Ni, Pt, Ru, and Rh, the second metal layer 120 may have a higher tensile strength than the first metal layer 110.

The second forming step S200 may include the second plating solution manufacturing step S210 and the second plating step S220.

The second plating solution manufacturing step S210 may be a step of manufacturing the second plating solution including Ni ions, Cl ions, boric acid ions, sodium dodecyl sulfate (SDS), and saccharin.

The second plating solution manufacturing step S210 may be a step of manufacturing the second plating solution including Ni ions, Cl ions, boric acid ions, SDS, and saccharin by mixing Ni (II) sulfate hexahydrate (NiSO₄·6H₂O), Ni (II) chloride hexahydrate (NiCl₂·6H₂O), boric acid (H₃BO₃), SDS, and saccharin.

Saccharin mixed to manufacture the second plating solution including saccharin in the second plating solution manufacturing step S210 may be saccharin sodium salt, i.e., a type of sodium salt. Particularly, saccharin may be saccharin sodium dehydrate.

That is, the second plating solution manufacturing step S210 may be a step of manufacturing the second plating solution containing saccharin by mixing saccharin sodium dehydrate in the manufacturing of the second plating solution.

Ni ions contained in the second plating solution manufactured in the second plating solution manufacturing step S210 are intended to be reduced in the second plating step S220 so as to form the second metal layer 120. The concentration of Ni ions contained in the second plating solution manufactured in the second plating solution manufacturing step S210 may be in the range of 0.3 to 3 M.

Ni ions contained in the second plating solution manufactured in the second plating solution manufacturing step S210 may be contained in the second plating solution due to sulfuric acid nickel and nickel chloride mixed in the manufacturing of the second plating solution.

Cl ions contained in the second plating solution manufactured in the second plating solution manufacturing step S210 are included to assist in the formation of the second metal layer 120 in the second plating step S220. Cl ions may be contained in the second plating solution due to nickel chloride mixed in the manufacturing of the second plating solution.

The second plating solution manufactured in the second plating solution manufacturing step S210 may include 0.1 to 1M of Cl ions.

Boric acid ions contained in the second plating solution manufactured in the second plating solution manufacturing step S210 are intended to maintain the pH of the second plating solution manufactured in the second plating solution manufacturing step S210 so that the second metal layer 120 is properly formed in the second plating step S220. Boric acid ions may be contained in the second plating solution due to boric acid mixed in the manufacturing of the second plating solution.

The second plating solution manufactured in the second plating solution manufacturing step S210 may include 0.3 to 1 M of boric acid ions.

When the concentration of boric acid ions contained in the second plating solution manufactured in the second plating solution manufacturing step S210 are lower than 0.3 M or higher than 1 M, the pH of the second plating solution may be excessively high or low, and thus the second metal layer 120 may not be properly formed in the second plating step S220.

SDS contained in the second plating solution manufactured in the second plating solution manufacturing step S210 is intended to act as a surfactant in the second plating step S220 in order to prevent hydrogen from being adsorbed to the boundary in the formation of the second metal layer 120 so that the second metal layer 120 is properly formed, and so that the second metal layer 120 is formed to have a microscopic structure including pillar-shaped grains, the size of which is several micrometers. SDS may be contained in the second plating solution due to SDS mixed in the manufacturing of the second plating solution.

The second plating solution manufactured in the second plating solution manufacturing step S210 may include 0.002 to 0.007 M of SDS.

Saccharin contained in the second plating solution manufactured in the second plating solution manufacturing step S210 is added for stress relaxation and grain refinement of the second metal layer 120 formed in the second plating step S220. Saccharin may be contained in the second plating solution due to saccharin mixed in the manufacturing of the second plating solution.

When saccharin is contained in the second plating solution manufactured in the second plating solution manufacturing step S210, the second metal layer 120 formed in the second plating step S220 may be less recrystallized than the first metal layer 110 so as to have finer grains. Thus, the second metal layer 120 may be comprised of nanometer-sized grains, and thus may have a higher level of tensile strength.

In addition, since SDS and saccharin are contained in the second plating solution manufactured in the second plating solution manufacturing step S210, the second metal layer 120 formed in the second plating step S220 may have a microscopic structure in which round (equiaxial) grains, the size of which is in the range of tens to hundreds of nanometers, are formed, and thus may have a higher tensile strength.

The second plating solution manufactured in the second plating solution manufacturing step S210 may include 0.003 to 0.011M of saccharin.

When the concentration of saccharin contained in the second plating solution manufactured in the second plating solution manufacturing step S210 is lower than 0.003 M, grains of the second metal layer 120 formed in the second plating step S220 are relatively larger and thus have no equiaxial crystal shape. Accordingly, the tensile strength of the second metal layer 120 may be relatively lowered.

When the concentration of saccharin contained in the second plating solution manufactured in the second plating solution manufacturing step S210 is higher than 011 M, grains of the second metal layer 120 formed in the second plating step S220 may not properly grow, and thus the second metal layer 120 may not be properly formed.

In addition, when the concentration of SDS contained in the second plating solution manufactured in the second plating solution manufacturing step S210 is lower than 0.002 M or higher than 0.007 M, grains of the second metal layer 120 formed in the second plating step S220 may have no round (equiaxial) crystal shape, the size of which is in the range of tens to hundreds of nanometers, and thus the second metal layer 120 may have a relatively low tensile strength.

The second plating step S220 may be a step of forming the second metal layer 120 by immersing the substrate having the first metal layer 110 into the second plating solution manufactured in the second plating solution manufacturing step S210, followed by electroplating.

The second plating step S220 may be a step of immersing the substrate, the surface of which is plated with the first metal layer 110, into the second plating solution manufactured in the second plating solution manufacturing step S210, immersing an oxidation electrode and a reduction electrode into the second plating solution, in which the substrate is immersed, and electroplating the first metal layer 110 with the second metal layer 120 applying current to the second plating solution.

The second plating step S220 may be a step of forming the second metal layer 120 by electroplating by applying current to the second plating solution so that a calculatable current density value according to the reaction area between the substrate and the second plating solution is 50 to 500 mA/cm2.

In the formation of the second metal layer 120 in the second plating step S220, when the calculatable current density value according to the reaction area between the substrate and the second plating solution is lower than 50 A/cm2, grains in the second metal layer 120 formed may irregularly grow. When the calculatable current density value is higher than 500 mA/cm2, a side reaction may occur in the formation of the second metal layer 120, thereby lowering the physical properties of the second metal layer 120.

In the formation of the second metal layer 120 in the second plating step S220, the temperature of the second plating solution may be maintained in the range of 40 to 60° C. so that the second metal layer 120 is properly formed, and the second metal layer 120 may be formed while stirring the second plating solution.

Here, the method of stirring the second plating solution may not be limited as long as the formation of the first metal layer 110 on the substrate is not interrupted. For example, the method may use at least one among stirring using a magnetic bar, stirring using a paddle, stirring using flow of the plating solution and nozzle spraying, stirring using the movement of an object to be plated, and air stirring.

The thickness of the multilayer metal thin plate 100 manufactured by the method of manufacturing a multilayer metal thin plate by electroplating according to an embodiment of the present disclosure may be equal to or lower than 10 μm. The lower limit of the thickness is not specified but may not be higher than 0 μm.

In addition, in the multilayer metal thin plate 100, the ratio of the thickness of the second metal layer 120 with respect to the first metal layer 110 may be adjusted without limitations, depending on the use of the multilayer metal thin plate 100. For example, the ratio of the thickness of the second metal layer 120 with respect to the first metal layer 110 may be in the range of 1 to 9 or, more particularly, 1.

### Example 1

(1) Formation of First Metal Layer

First, a first plating solution including 1 M of Cu ions, 1 M of sulfuric acid, 0.84 mM of sodium chloride, 0.09 μM of polyethylene glycol, and 50 μM of SPS was manufactured by mixing copper sulfate, sulfuric acid, NaCl, polyethylene glycol as a plating suppressor, and SPS as a plating accelerator. Here, the polyethylene glycol used had an average molecular weight of 3350 g/mol.

A first metal layer 110 was formed on a substrate by electroplating by immersing the substrate, as well as an oxidation electrode and a reduction electrode, into the first plating solution and then applying current to the first plating solution using the oxidation electrode and the reduction electrode so that a calculatable current density value according to the reaction area between the substrate and the first plating solution is 50 mA/cm2. Here, the substrate was implemented as a stainless substrate.

Here, in the application of the current, the temperature of the plating solution was maintained at 30° C., and the current was applied while stirring the plating solution using a magnetic bar, thereby forming the first metal layer 110 having a thickness of 5 μm.

(2) Formation of Second Metal Layer

A second plating solution including 1.2 M of Ni ions, 0.4 M of Cl ions, 0.7 M of boric acid ions, 0.003 M of SDS, and 0.004 M of saccharin was manufactured by mixing nickel sulfate, nickel chloride, boric acid, SDS, and saccharin sodium dehydrate.

A multilayer metal thin plate 100 was manufactured by electroplating the first metal layer 110 with a second metal layer 120 by immersing the substrate having the first metal layer 110 formed thereon, as well as the oxidation electrode and the reduction electrode, into the second plating solution and then applying current to the second plating solution using the oxidation electrode and the reduction electrode so that the calculatable current density value according to the reaction area between the second plating solution and the substrate is 100 mA/cm2.

Here, in the application of the current, the temperature of the plating solution was maintained at 50° C., and the current was applied while stirring the plating solution using a magnetic bar, thereby forming the second metal layer 120 having a thickness of 5 μm.

### Example 2

(1) Formation of Second Metal Layer

A second plating solution including 1.2 M of Ni ions, 0.4 M of Cl ions, 0.7 M of boric acid ions, 0.003 M of SDS, and 0.004 M of saccharin was manufactured by mixing nickel sulfate, nickel chloride, boric acid, SDS, and saccharin sodium dehydrate.

A second metal layer 120 was formed on the substrate by electroplating by immersing the substrate, as well as an oxidation electrode and a reduction electrode, into the second plating solution and then applying current to the second plating solution using the oxidation electrode and the reduction electrode so that the calculatable current density value according to the reaction area between the second plating solution and the substrate is 100 mA/cm2.

Here, in the application of the current, the temperature of the plating solution was maintained at 50° C., and the current was applied while stirring the plating solution using a magnetic bar, thereby forming the second metal layer 120 having a thickness of 5 μm.

(2) Formation of First Metal Layer

A first plating solution including 1 M of Cu ions, 1 M of sulfuric acid, 0.84 mM of sodium chloride, 0.09 μM of polyethylene glycol, and 50 μM of SPS was manufactured by mixing copper sulfate, sulfuric acid, NaCl, polyethylene glycol as a plating suppressor, and SPS as a plating accelerator. Here, the polyethylene glycol used had an average molecular weight of 3350 g/mol.

A multilayer metal thin plate 100 was manufactured by electroplating the second metal layer 120 with a first metal layer 110 by immersing the substrate having the second metal layer 120 thereon, as well as the oxidation electrode and the reduction electrode, into the first plating solution and then applying current to the first plating solution using the oxidation electrode and the reduction electrode so that a calculatable current density value according to the reaction area between the substrate and the first plating solution is 50 mA/cm2.

Here, in the application of the current, the temperature of the plating solution was maintained at 30° C., and the current was applied while stirring the plating solution using the magnetic bar, thereby forming the first metal layer 110 having a thickness of 5 μm.

### Example 3

A multilayer metal thin plate 100 was manufactured in the same method as in Example 1.

Here, after the second metal layer 120 was formed, the multilayer metal thin plate 100 was peeled off from the substrate. The peeled multilayer metal thin plate 100 was heat-treated at 190° C. for 10 minutes.

### Example 4

A multilayer metal thin plate 100 was manufactured in the same method as in Example 2.

Here, after the first metal layer 110 was formed, the multilayer metal thin plate 100 was peeled off from the substrate. The peeled multilayer metal thin plate 100 was heat-treated at 190° C. for 10 minutes.

### Comparative Example 1

A multilayer metal thin plate 100 was manufactured in the same method as in Example 1. Here, in the manufacturing of the second plating solution, the second plating solution including 1.2 M of Ni ions, 0.4 M of Cl ions, 0.7 M of boric acid ions, and 0.003 M of SDS was manufactured by mixing nickel sulfate, nickel chloride, boric acid, and SDS.

### Comparative Example 2

A multilayer metal thin plate 100 was manufactured in the same method as in Example 2. Here, in the manufacturing of the second plating solution, the second plating solution including 1.2 M of Ni ions, 0.4 M of Cl ions, 0.7 M of boric acid ions, and 0.003 M of SDS was manufactured by mixing nickel sulfate, nickel chloride, boric acid, and SDS.

### Comparative Example 3

A multilayer metal thin plate 100 was manufactured in the same method as in Example 1. Here, after the second metal layer 120 was formed, the multilayer metal thin plate 100 was peeled off from the substrate, and the peeled multilayer metal thin plate 100 was heat-treated at 190° C. for 10 minutes.

### Comparative Example 4

A multilayer metal thin plate 100 was manufactured in the same method as in Example 2. Here, after the first metal layer 110 was formed, the multilayer metal thin plate 100 was peeled off from the substrate, and the peeled multilayer metal thin plate 100 was heat-treated at 190° C. for 10 minutes.

### Comparative Example 5

A first plating solution the same as the first plating solution manufactured in (1) Formation of First Metal Layer of Example 1 was manufactured.

The first metal layer 110 was formed on a substrate by immersing the substrate, as well as an oxidation electrode and a reduction electrode, into the first plating solution and then applying current to the first plating solution using the oxidation electrode and the reduction electrode so that the calculatable current density value according to the reaction area between the substrate and the first plating solution is 50 mA/cm2.

Here, in the application of the current, the temperature of the plating solution was maintained at 30° C., and the current was applied while stirring the plating solution using the magnetic bar, thereby forming the first metal layer 110 having a thickness of 10 μm.

The first metal layer 110 was peeled off from the substrate, and the peeled first metal layer 110 was heat-treated at 190° C. for 10 minutes.

### Comparative Example 6

A second plating solution including 1.2 M of Ni ions, 0.4 M of Cl ions, 0.7 M of boric acid ions, and 0.003 M of SDS was manufactured by mixing nickel sulfate, nickel chloride, boric acid, and SDS.

A second metal layer 120 was formed on a substrate by electroplating by immersing the substrate, as well as an oxidation electrode and a reduction electrode, into the second plating solution, and applying current to the second plating solution using the oxidation electrode and the reduction electrode so that the calculatable current density value according to the reaction area between the second plating solution and the substrate is 100 mA/cm2.

Here, in the application of the current, the temperature of the plating solution was maintained at 50° C., and the current was applied while stirring the plating solution using a magnetic bar, thereby forming the second metal layer 120 having a thickness of 10 μm.

The second metal layer 120 was peeled off from the substrate. The peeled second metal layer 120 was heat-treated at 190° C. for 10 minutes.

### Comparative Example 7

A second plating solution, the same as the second plating solution manufactured in (2) Formation of Second Metal Layer of Example 1, was manufactured.

A second metal layer 120 was formed on the substrate by electroplating by immersing the substrate, as well as an oxidation electrode and a reduction electrode, into the second plating solution and then applying current to the second plating solution using the oxidation electrode and the reduction electrode so that the calculatable current density value according to the reaction area between the second plating solution and the substrate is 100 mA/cm2.

Here, in the application of the current, the temperature of the plating solution was maintained at 50° C., and the current was applied while stirring the plating solution using a magnetic bar, thereby forming the second metal layer 120 having a thickness of 10 μm.

The second metal layer 120 was peeled off from the substrate. The peeled second metal layer 120 was heat-treated at 190° C. for 10 minutes.

### Test Example 1

In Test Example 1, the tensile strength, elongation, and specific resistance of each of the multilayer metal thin plates 100 manufactured according to Examples 1 to 4, the multilayer metal thin plates 100 manufactured according to Comparative Examples 1 to 4, the first metal layer 110 manufactured according to Comparative Example 5, and the second metal layers 120 manufactured according to Comparative Examples 6 and 7 were measured.

The tensile strength and the elongation were measured by a uniaxial tensile test, and the specific resistance was calculated by multiplying the sheet resistance measured by a sheet resistance meter (4-point probe) with the thickness. The measured tensile strengths, elongations, and specific resistance are summarized in Table 1.

TABLE 1

| | Tensile Strength | | Specific Resistance |
|---|---|---|---|
| | (kgf/mm²) | Elongation (%) | (×10⁻⁸ Ωm) |
| Ex. 1 | 104.5 | 4.5 | 3.6 |
| Ex. 2 | 111.4 | 5.3 | 3.4 |
| Ex. 3 | 90.4 | 4.0 | 3.1 |
| Ex. 4 | 74.3 | 2.5 | 3.0 |
| Comp. Ex. 1 | 85.9 | 3.5 | 3.3 |
| Comp. Ex. 2 | 85.9 | 4.1 | 3.1 |
| Comp. Ex. 3 | 57.3 | 2.7 | 2.8 |
| Comp. Ex. 4 | 52.1 | 3.6 | 2.6 |
| Comp. Ex. 5 | 28.2 | 7.1 | 1.9 |
| Comp. Ex. 6 | 58.8 | 1.9 | 7.2 |
| Comp. Ex. 7 | 136.6 | 4.2 | 9.6 |

Referring to Table 1, it can be seen that the tensile strength of each of the multilayer metal thin plates 100 manufactured according to Examples 1 to 2 is higher than the tensile strength of the first metal layer 110 manufactured according to Comparative Example 5. This result indicates that the tensile strength was improved when the multilayer metal thin plate 100 including the first metal layer 110 and the second metal layer 120 was used compared to when the first metal layer 110 was used alone.

In addition, it is known that a Cu thin film used for a negative current collector of a secondary battery is in contact with an active material in the subsequent fabrication processing, thereby allowing the secondary battery to be completed. During the fabrication processing, thermal or mechanical load may be applied to the Cu thin film, thereby causing a defect in the Cu thin film such as wrinkling or tearing. It is also known that when a reaction occurs between the Cu thin film and the active material due to impacts and thermal deformations occurring during the use of the secondary battery, the reaction may significantly degrade characteristics of the Cu thin film such as electrical resistance and mechanical strength.

Heat-treating the multilayer metal thin plates 100 manufactured according to Examples 3 and 4 and Comparative Examples 3 and 4, the first metal layer 110 manufactured according to Comparative Example 5, and the second metal layer 120 manufactured according to Comparative Example 6 to 7 during the manufacturing thereof is performed by considering degradations in the electrical resistance and mechanical strength due to the reaction between the Cu thin film and the active material caused by thermal load during the fabrication processing of the secondary battery or thermal deformation during the use of the secondary battery.

More specifically, Examples 3 and 4 are manufactured by heat-treating the multilayer metal thin plates 100 manufactured according to Examples 1 and 2, while Comparative Examples 3 and 4 are manufactured by heat-treating the multilayer metal thin plates 100 manufactured according to Comparative Examples 1 and 2. In addition, Comparative Example 5 is manufactured by heat-treating the metal thin film only including the first metal layer 110, while each of Comparative Examples 6 and 7 is manufactured by heat-treating the metal thin film only including the second metal layer 120.

It can be seen that the tensile strength of each of the multilayer metal thin plates 100 manufactured according to heat-treated Examples 3 and 4 is improved to be 2.6 to 3.2 times the tensile strength of the first metal layer 110 manufactured according to Comparative Example 5.

This result indicates that the metal thin film only including the first metal layer 110 is more degraded in the mechanical strength due to a reaction with the active material occurring due to the thermal load during the fabrication processing of the secondary battery and the thermal deformation during the use of the secondary battery than each of the multilayer metal thin plates 100 manufactured according to Examples 3 and 4.

It is understood that since each of the multilayer metal thin plates 100 manufactured according to Examples 3 and 4 is configured such that the second metal layer 120 is formed on the first metal layer 110, the second metal layer 120 may protect the first metal layer 110 and prevent a reaction between the first metal layer 110 and the active material occurring due to thermal load during the manufacturing processing of a secondary cell or thermal deformation during the use of the secondary cell, thereby lowering the mechanical strength of the first metal layer 110.

Regarding the tensile strength, elongation, and specific resistance of each of the multilayer metal thin plates 100 manufactured according to Examples 3 and 4, it can be seen that there no significant difference in either the elongation or the specific resistance between the multilayer metal thin plate 100 manufactured according to Example 3 and the multilayer metal thin plate 100 manufactured according to Example 4, but the tensile strength of the multilayer metal thin plate 100 manufactured according to Example 3 is improved than the tensile strength of the multilayer metal thin plate 100 manufactured according to Example 4. This result indicates that in the manufacturing of the multilayer metal thin plate 100, the multilayer metal thin plate 100 having improved tensile strength may be manufactured when the first metal layer 110 is formed before the second metal layer 120.

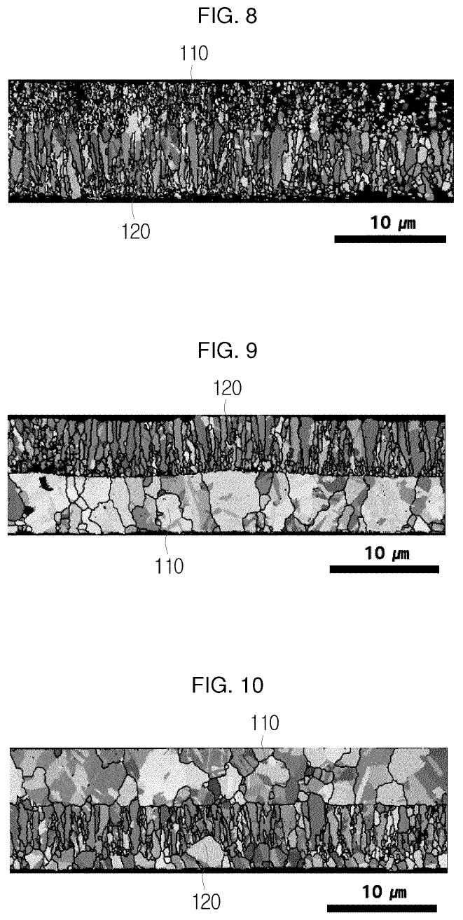

Referring to FIGS. 9 and 10, it can be seen that the size of grains in the lower portion of the second metal layer 120 of the multilayer metal thin plate 100 manufactured according to Comparative Example 3 illustrated in FIG. 9 is smaller than the size of grains in the lower portion of the second metal layer 120 of the multilayer metal thin plate 100 manufactured according to Comparative Example 4 illustrated in FIG. 10. It may be suggested that electron backscatter diffraction (EBSD) analysis as illustrated in FIGS. 3 to 6 was not performed since the grains of the second metal layer 120 included in each of the multilayer metal thin plates 100 manufactured according to Examples 1 to 4 are refined, but according to the tendency of the sizes of the grains in the lower portion of the second metal layer 120 included in each of the multilayer metal thin plates 100 manufactured according to Comparative Example 3 and Comparative Example 4 illustrated in FIGS. 9 and 10, when the first metal layer 110 is formed on the substrate before the second metal layer 120, the size of the grains in the lower portion of the second metal layer 120 may be further refined to improve the tensile strength of the second metal layer 120.

Regarding the tensile strength, elongation, and the specific resistance of each of the multilayer metal thin plates 100 manufactured according to Example 3 and Comparative Example 3, it can be seen that there is not a significant difference in the specific resistance between the multilayer metal thin plate 100 manufactured according to Example 3 and the multilayer metal thin plate 100 manufactured according to Comparative Example 3, but the tensile strength and the elongation of the multilayer metal thin plate 100 manufactured according to Example 3 are higher than those of the multilayer metal thin plate 100 manufactured according to Comparative Example 3. This result indicates that mechanical properties of multilayer metal thin plate 100 are significantly improved when the second plating solution including saccharin is used in the formation of the second metal layer 120. It can be seen that this tendency appears in the multilayer metal thin plate 100 manufactured according to Comparative Example 4 in a similar manner.

In addition, it can be seen that the tensile strength and elongation of the second metal layer 120 manufactured according to Comparative Example 7 are higher than the tensile strength and elongation of the second metal layer 120 manufactured according to Comparative Example 6. This result indicates that when saccharin is contained in the second plating solution in the manufacturing of the second metal layer 120, the mechanical properties of the second metal layer 120 are improved.

### Test Example 2

In Test Example 2, the cross-sections of the multilayer metal thin plates 100 manufactured according to Examples 1 to 4 and the multilayer metal thin plates 100 manufactured according to Comparative Examples 1 to 7 were analyzed by EBSD analysis in order to examine the microscopic structures of the multilayer metal thin plates 100 manufactured according to Examples 1 to 4 and the multilayer metal thin plates 100 manufactured according to Comparative Examples 1 to 7.

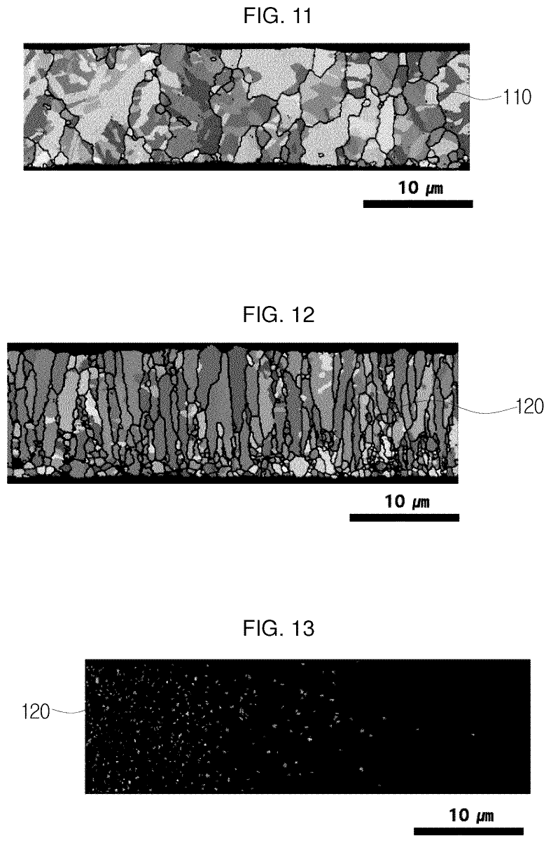

Analysis results are illustrated in FIGS. 3 to 13. In each of the first metal layers 110 and the second metal layers 120 illustrated in FIGS. 3 to 13, EBSD was not measured in a black area since the grain size thereof is as small as nanometers.

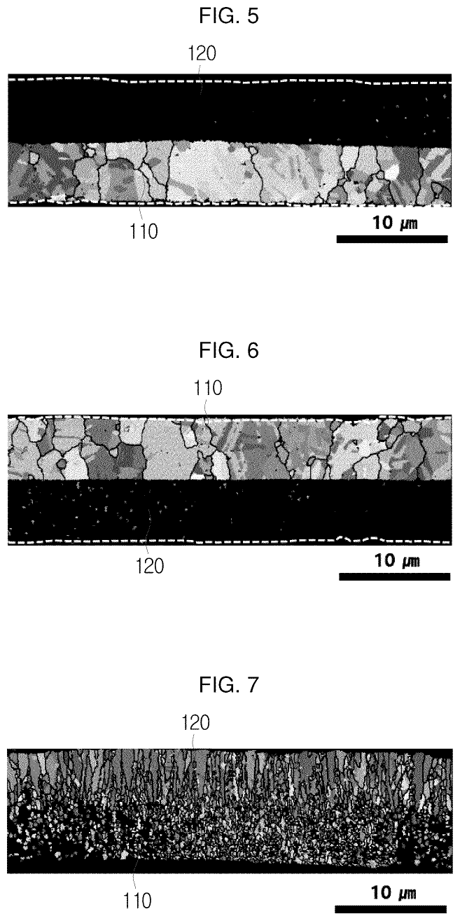

Comparing FIGS. 3 and 5 with FIGS. 4 and 6, it can be seen that the grains of the multilayer metal thin plates 100 illustrated in FIGS. 5 and 6 are greater than the grains of the multilayer metal thin plates 100 illustrated in FIGS. 3 and 4. It may be understood that the grains of the first metal layer 110 and the second metal layer 120 of the multilayer metal thin plate 100 were grown when the multilayer metal thin plate 100 was heat-treated.

Comparing FIGS. 3 and 7, FIGS. 4 and 8, FIGS. 5 and 9, and FIGS. 6 and 10, it can be seen that the grains of the multilayer metal thin plates 100 illustrated in FIGS. 7, 8, 9, and 10 are greater than the grains of the multilayer metal thin plates 100 illustrated in FIGS. 3, 4, 5, and 6. This result indicates that saccharin contained in the second plating solution causes the size of the grains of the second metal layer 120 in each of the manufactured multilayer metal thin plates 100 to be finer.

In addition, referring to FIGS. 12 and 13, it can be seen that the grains of the second metal layer 120 manufactured according to Comparative Example 7 were finer than the grains of the second metal layer 120 manufactured according to Comparative Example 6. More specifically, referring to FIGS. 12 and 13, it can be seen that the grains of the second metal layer 120 manufactured according to Comparative Example 6 were measured by EBSD, but the grains the second metal layer 120 manufactured according to Comparative Example 7 were too fine to be analyzed.

Accordingly, the present disclosure has been made keeping in mind the above problems occurring in the related art, and the present disclosure is intended to propose a method of manufacturing a multilayer metal thin plate by electroplating and a multilayer metal thin plate manufactured thereby, wherein the multilayer metal thin plate has a thickness in the range of several to tens of micrometers and includes a plurality of metal layers having different grain sizes in order to increase the durability of either a secondary battery or a fuel cell.

The objective of the present disclosure is not limited to the description, and other objectives not explicitly disclosed herein will be clearly understood by those skilled in in the art from the description provided hereinafter.

In order to achieve at least one of the above objectives, according to one aspect of the present disclosure, there is provided a method of manufacturing a multilayer metal thin plate by electroplating, the method including: a first forming operation of forming one of a first metal layer and a second metal layer on a substrate by electroplating, wherein the second metal layer is less recrystallized than the first metal layer, is included of nanometer-size grains, and has a higher level of tensile strength than the first metal layer; and a second forming operation of forming, by electroplating, a metal layer not formed in the first forming operation on a surface of one of the first metal layer and the second metal layer formed in the first forming operation.

According to another aspect of the present disclosure, there is provided a multilayer metal thin plate including: a first metal layer; and a second metal layer formed on the first metal layer, less recrystallized than the first metal layer, included of nanometer-size grains, and having a higher level of tensile strength than the first metal layer.

From the method of manufacturing a multilayer metal thin plate by electroplating and the multilayer metal thin plate manufactured thereby according to embodiments of the present disclosure, the following effects may be obtained.

Since the multilayer metal thin plate has a structure in which the first metal layer and the second metal layer having different sizes of grains are formed, the tensile strength of the multilayer metal thin plate is improved. When the multilayer metal thin plate is used in either a secondary battery or a fuel cell, the durability of either the secondary battery or the fuel cell may be improved.

More specifically, the multilayer metal thin plate may include the first metal layer made of a metal including one selected from among copper (Cu), silver (Ag), and gold (Au) and the second metal layer made of a metal including one selected from among nickel (Ni), platinum (Pt), ruthenium (Ru), and rhodium (Rh), and thus may have superior durability.

Although the exemplary embodiments of the present disclosure have been described for illustrative purposes with reference to the accompanying drawings, those skilled in the art will appreciate that various modifications, additions, and substitutions are possible, without departing from the scope and spirit of the present disclosure as disclosed in the accompanying claims. Accordingly, the foregoing embodiments disclosed herein shall be interpreted as being illustrative, while not being limitative, in all aspects. It should be understood that the scope of the present disclosure shall be defined by the appended Claims rather than by the foregoing embodiments, and that all of modifications and alterations derived from the definition of the Claims and their equivalents fall within the scope of the present disclosure.

What is claimed is:

1. A method of manufacturing a multilayer metal plate by electroplating, the method comprising:
a first forming operation of forming one of a first metal layer and a second metal layer on a substrate by electroplating, wherein the second metal layer is less recrystallized than the first metal layer, the second metal layer is comprised of nanometer-size grains, and the second metal layer has a higher level of tensile strength than the first metal layer; and
a second forming operation of forming, by electroplating, a third metal layer not formed in the first forming operation on a surface of one of the first metal layer and the second metal layer formed in the first forming operation.

2. The method of claim 1, wherein the multilayer metal plate is manufactured having a thickness higher than 0 μm and being equal to or lower than 10 μm, and having a tensile strength of 74.3 to 111.4 kgf/mm2.

3. The method of claim 1,
wherein, in the first forming operation, the first metal layer comprising a metal including at least one selected from among Cu, Ag, and Au is formed, and
wherein in the second forming operation, the second metal layer comprising a metal including at least one selected from among Ni, Pt, Ru, and Rh is formed.

4. The method of claim 3, wherein the multilayer metal plate in which a ratio of the thickness of the second metal layer with respect to the first metal layer is 1 to 9 is manufactured.

5. The method of claim 1, wherein the first forming operation comprises:
manufacturing a first plating solution comprising Cu ions, sulfuric acid, Cl ions, a plating suppressor, and a plating accelerator; and
immersing the substrate into the first plating solution and electroplating the substrate with the first metal layer,
wherein the second forming operation comprises:
manufacturing a second plating solution comprising Ni ions, Cl ions, boric acid ions, sodium dodecyl sulfate, and saccharin; and
immersing the substrate having the first metal layer thereon into the second plating solution and forming the second metal layer by electroplating.

6. The method of claim 5,
wherein the manufacturing of the first plating solution manufactures the first plating solution comprising 0.3 to 1 M of the Cu ions, 0.1 to 2 M of the sulfuric acid, 0.5 to 1 mM of the Cl ions, 0.06 to 0.1 μM of polyethylene glycol as the plating suppressor, and 15 to 100 μM of sodium dodecyl sulfate as the plating accelerator, and
wherein the electroplating of the first metal layer electroplates the first metal layer by applying current to the first plating solution so that a countable current density value according to a reaction area between the substrate and the first plating solution is 50 to 300 mA/cm2.

7. The method of claim 5,
wherein the manufacturing of the second plating solution manufactures the second plating solution comprising 0.3 to 3 M of the Ni ions, 0.1 to 1 M of the Cl ions, 0.3 to 1 M of the boric acid ions, 0.002 to 0.007 M of the sodium dodecyl sulfate, and 0.003 to 0.011 M of the saccharin, and
wherein the electroplating of the second metal layer electroplates the second metal layer by applying current to the second plating solution so that a countable current density value according to a reaction area between the substrate and the second plating solution is 50 to 500 mA/cm2.

8. A multilayer metal plate comprising:
a first metal layer; and
a second metal layer formed on the first metal layer,
wherein the second metal layer is less recrystallized than the first metal layer,
wherein the second metal layer is comprised of nanometer-size grains, and
wherein the second metal layer includes a higher level of tensile strength than the first metal layer.

9. The multilayer metal plate of claim 8, wherein the multilayer metal plate has a thickness of higher than 0 μm and being equal to or lower than 10 μm, and a tensile strength of 74.3 to 111.4 kgf/mm2.

10. The multilayer metal plate of claim 8,
wherein the first metal layer comprises a metal including at least one selected from among Cu, Ag, and Au, and
wherein the second metal layer comprises a metal including at least one selected from among Ni, Pt, Ru, and Rh.

11. The multilayer metal plate of claim 8, wherein, in case the multilayer metal plate is used as a negative electrode current collector in a rechargeable battery or a fuel cell, the different sizes of grains in the first metal layer, the second metal layer, and the third metal layer improve tensile strength and increase durability of the multilayer metal plate in comparison to a multilayer metal plate comprising one or two metal layers.

12. The method of claim 1, wherein, in case the multilayer metal plate is used as a negative electrode current collector in a rechargeable battery or a fuel cell, the different sizes of grains in the first metal layer, the second metal layer, and the third metal layer improve tensile strength and increase durability of the multilayer metal plate in comparison to a multilayer metal plate comprising one or two metal layers.
